(19) United States
(12) Patent Application Publication
(10) Pub. No.: US 2026/0062997 A1
(43) Pub. Date: Mar. 5, 2026

(54) ANIMAL LADDERS AND METHODS OF USING THE SAME

(71) Applicant: Nauti Dawgs LLC, Prospect, KY (US)

(72) Inventors: Troy Bruce, Prospect, KY (US); Alex Misener, Prospect, KY (US)

(21) Appl. No.: 19/321,056

(22) Filed: Sep. 5, 2025

Related U.S. Application Data
(60) Provisional application No. 63/691,135, filed on Sep. 5, 2024.

(51) Int. Cl. E06C 1/34; E06C 1/383; E06C 1/387

(52) U.S. Cl. CPC E06C 1/34; E06C 1/383; E06C 1/387

(57) ABSTRACT

Collapsible, portable, adjustable, removable, and/or detachable ladders and methods that can be easily deployed to assist a dog or other animal when entering or exiting a structure.

### REFERENCED APPLICATION

The present disclosure claims priority on U.S. Provisional Patent Application Ser. No. 63/691,135 filed on Sep. 5, 2024, which is fully incorporated herein by reference.

### FIELD OF DISCLOSURE

The present disclosure relates generally to ladders and methods for ingress and egress from and to a structure, and more particularly to ladders and methods that assist dogs when entering and exiting a structure, and even more particularly to collapsible, portable, adjustable, removable, and/or detachable ladders and methods for using such ladders that can be easily deployed to assist a dog or other animal when exiting water and/or entering a structure such as, but not limited to, a boat, boat dock, lake platform, wall, deck, swim platforms, ski boats, house boats, pontoon boats, crusiers, hunting boats, boat docks, or other type of structure.

### BACKGROUND OF DISCLOSURE

Ladders and other similar stepped apparatuses are commonplace in modern society. Traditionally, such ladders were seen only in household maintenance settings, construction sites, offices, or other similar commercial and residential settings; however, these ladders have more recently expanded into pet and animal settings as well. Accordingly, there has been an increase in animals accompanying humans and/or owners during various activities.

Commercially available pet and animal ladders: (i) are non-portable and often remain affixed to the accompanying structure; (ii) are difficult and laborious to affix to and/or remove from the accompanying structure; (iii) result in damage to the accompanying structure; and/or (iv) are custom manufactured to correspond to the accompanying structure.

As such, there is an ongoing need for collapsible, portable, adjustable, removable, and/or detachable ladders and methods relating to the same that can be easily deployed to assist a dog or other animal enter and/or exit a structure (e.g. boat, jet ski, kayak, watercraft, raft, dock, pool, aquatic platform, non-aquatic platform, hunting stand, trechouse, vehicles, boat dock, lake platform, wall, deck, swim platforms, ski boats, house boats, pontoon boats, crusiers, hunting boats, or other type of structure, etc.). The disclosed ladders and methods address other deficiencies of prior art ladder devices, systems, and methods.

### SUMMARY OF THE DISCLOSURE

The present disclosure relates generally to ladders and methods for ingress and egress from and to a structure, particularly to ladders and methods for using the ladders that assist dogs and other animals to ingress and egress from a structure, and more particularly to collapsible, portable, adjustable, removable, and/or detachable ladders and methods for using such ladders that can be easily deployed to assist a dog and other animals when exiting the water and/or entering a structure such as, but not limited to, a boat, jet ski, kayak, watercraft, raft, dock, pool, aquatic platform, non-aquatic platform, hunting stand, treehouse, vehicles, boat dock, lake platform, wall, deck, swim platforms, ski boats, house boats, pontoon boats, crusiers, hunting boats, or other type of structure, etc.

In one non-limiting embodiment of the present invention, the present disclosure specifically aids a dog when entering and/or exiting a boat, jet ski, kayak, watercraft, raft, dock, pool, aquatic platform, etc. Although the present disclosure will particularly discuss ladders, ladder assemblies, and methods for use in aquatic environments, it will be appreciated that the ladders, ladder assemblies, and methods in accordance with the present disclosure can be used with other types of structures and/or applications (e.g. hunting stands and other types of stands, non-aquatic platforms, vehicles, trains, airplanes, other types of elevated structures, steps, etc.) in which an animal is to accompany an individual or needs to enter or exit.

Some non-limiting advantages of the disclosed technology include the following: (i) the ladder assembly includes a mounting bracket that can be adjusted to accommodate gunnels, lips, edges, hulls, platforms, etc. having varying sizes; (ii) the mounting brackets include one or more pads that mitigate damage to the accompanying structure to which it is affixed; (iii) the ladder assembly can be collapsed into a portable configuration; and/or (iv) the ladder assembly can easily be affixed and deployed to the accompanying structure.

In one non-limiting object of the present disclosure, there is the provision of a ladder assembly and method of use to assist dogs and other animals to ingress and egress from a structure.

In another non-limiting object of the present disclosure, there is the provision of a ladder assembly and method of use that includes a collapsible, portable, adjustable, removable, and/or detachable ladder that can be easily deployed to assist a dog and other animals when exiting the water and/or entering a structure such as, but not limited to, a boat or a boat dock or a lake platform, wall, deck, or other type structure.

In another non-limiting object of the present disclosure, there is the provision of a ladder assembly comprising a ladder and a mounting bracket; the ladder is configured to releasably connect to the mounting bracket by a releasable connection arrangement; the mounting bracket is configured to connect to a structure to which the ladder assembly is to be connected thereto; the ladder includes a) a first ladder arm and a second ladder arm, b) a plurality of step arms, and c) a plurality of steps; the plurality of steps are rotatably positioned between the first and second ladder arms to enable the steps to move between a folded orientation and an unfolded orientation; each of the step arms are movable connected to two of the steps that are adjacently position to one another.

In another non-limiting object of the present disclosure, there is the provision of a ladder assembly wherein the ladder includes a stability arm and a cross bar; the stability arm is rigidly connected to a lower portion of the first and second ladder arms to connect together the first and second ladder arms; the cross bar is rigidly connected to an upper portion of the first and second ladder arms to connect together the first and second ladder arms.

In another non-limiting object of the present disclosure, there is the provision of a ladder assembly wherein each of the first and second ladder arms include a ladder hinge that is configured to enable the first and second ladder arms to pivot between an extended orientation and a folded orientation.

In another non-limiting object of the present disclosure, there is the provision of a ladder assembly wherein the ladder includes a side clip; the side clip is configured to move to a first position that engage at least a portion of one of the step arms and a second position that disengages from at least one the step arms; and wherein when the side clip is in the first position the side clip inhibits or prevents the steps that are connected to the step arm from moving between the folded orientation and the unfolded orientation; and wherein when the side clip is in the second position to disengage from the step arm, the side clip allows the steps that are connected to the step arm to move between the folded orientation and the unfolded orientation.

In another non-limiting object of the present disclosure, there is the provision of a ladder assembly wherein the side clip is movably connected to the first or second ladder arm.

In another non-limiting object of the present disclosure, there is the provision of a ladder assembly wherein the mounting bracket comprises a front plate and a back plate that are connected together wherein the first plate is substantially perpendicular to the back plate.

In another non-limiting object of the present disclosure, there is the provision of a ladder assembly wherein the mounting bracket includes one or more pads that are coupled to the front plate and/or the back plate.

In another non-limiting object of the present disclosure, there is the provision of a ladder assembly wherein the ladder includes a stability arm; the stability arm is rotatably connected to the first and second ladder arms such that the stability arm is movable between a folded and unfolded position.

In another non-limiting object of the present disclosure, there is the provision of a ladder assembly wherein the ladder includes one or more side clips positioned on one or both of the first and second ladder arms; each of the side clips is configured to engage at least a portion of the stability arm to hold the stability arm at a certain position relative to the first and/or second ladder arms.

In another non-limiting object of the present disclosure, there is the provision of a ladder assembly wherein one or more of the side clips includes a biased member that move between an open and closed position; and wherein when the side clip is in the open position the side clip is configured to engage the stability arm and limit movement of the stability arm; and wherein when the side clip is in the closed position the side clip is configured to allow the stability arm to move past the side clip.

In another non-limiting object of the present disclosure, there is the provision of a ladder assembly wherein the mounting bracket includes front plate, a back plate and a plate connection arrangement, and wherein the front and back plate are movably connected to one another; the plate connection arrangement is configured to releasably connect together the front and back plates so that the front and back plates are immovably connected together; and wherein the front and back plates form an adjustable connection gap that is used to connected the mounting bracket to the structure.

In another non-limiting object of the present disclosure, there is the provision of a ladder assembly wherein at least one of the front and back plates includes one or more channels to facilitate in movement of the front and back plates relative to one another.

In another non-limiting object of the present disclosure, there is the provision of a method for facilitating in enable an animal to exit a body of water and access a structure surface located above a top surface of the body of water; the method comprises: a) providing a ladder assembly; the ladder assembly comprising a ladder and a mounting bracket; the ladder is configured to releasably connect to the mounting bracket by a releasable connection arrangement; the mounting bracket is configured to connect to a structure to which the ladder assembly is to be connected thereto; the ladder includes a) a first ladder arm and a second ladder arm, b) a plurality of step arms, and c) a plurality of steps; the plurality of steps are rotatably positioned between the first and second ladder arms to enable the steps to move between a folded orientation and an unfolded orientation; each of the step arms are movable connected to two of the steps that are adjacently position to one another; b) connecting the mounting bracket to a portion of the structure; c) unfolding the ladder such that a bottom portion of the ladder is located closed adjacent to a top surface of the body of water or submerged in the body of water; d) unfolding the plurality of steps to the unfolded orientation; and c) allowing the animal to climb the plurality of steps so that the animal can exit the body of water and access the structure.

These and other objects and advantages will become apparent to those skilled in the art upon reading and following the description taken together with the accompanying drawings.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for case of recognition in the drawings. Reference may now be made to the drawings, which illustrate various embodiments that the disclosure may take in physical form and in certain parts and arrangement of parts wherein:

FIG. 1 depicts an isometric view of an exemplary, non-limiting ladder assembly/system comprising a non-limiting ladder shown in a fully assembled and extended orientation.

FIG. 2 is a side view of the ladder assembly/system of FIG. 1.

FIG. 3 is a front of the ladder assembly/system of FIG. 1.

FIG. 4 is a back of the ladder assembly/system of FIG. 1.

FIG. 5 is a front of the ladder assembly/system of FIG. 1 wherein the steps are in the folded orientation.

FIG. 6 is a back of the ladder assembly/system of FIG. 1 wherein the steps are in the folded orientation.

FIG. 7 depicts the ladder of FIG. 1 in the fully folded orientation.

FIG. 8 is an exploded view of the ladder of FIG. 1.

FIG. 9 is a perspective view of another alternative non-limiting configuration of the ladder assembly/system comprising a ladder shown in a fully assembled and extended orientation.

FIG. 10 is an exploded view of the ladder of FIG. 9.

FIGS. 11A-11B depict the ladder of FIG. 9 transitioning between an extended orientation (FIG. 11B) and a collapsed orientation (FIG. 11A).

FIG. 12 is an isometric view of the ladder of FIG. 9 in the fully collapsed orientation.

FIG. 13 is a perspective view of a non-limiting mounting bracket for the ladder of FIG. 9.

FIG. 14 is an exploded view of the mounting bracket of FIG. 13.

FIGS. 15-17 depict various adjustment distances of the mounting bracket of FIG. 13, wherein FIG. 15 depicts an exemplary minimum adjustment distance, wherein FIG. 16 depicts an intermediate adjustment distance, and wherein FIG. 17 depicts an exemplary maximum adjustment distance.

### DESCRIPTION OF NON-LIMITING EMBODIMENTS

A more complete understanding of the articles/devices, processes and components disclosed herein can be obtained by reference to the accompanying drawings. These figures are merely schematic representations based on convenience and the case of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

For the sake of simplicity, the attached figures may not show the various ways (readily discernable, based on this disclosure, by one of ordinary skill in the art) in which the disclosed system, method and apparatus can be used in combination with other systems, methods and apparatuses. Additionally, the description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

The present disclosure provides collapsible, portable, adjustable, removable, and/or detachable ladders, ladder assemblies, and methods relating to the same that can be easily deployed to assist a dog or other animal to enter and/or exit a structure. In one non-limiting embodiment of the present invention, the present disclosure specifically aids a dog when entering and/or exiting a boat, jet ski, kayak, watercraft, raft, dock, pool, aquatic platform, etc. Although the present disclosure will particularly discuss ladders, ladder assemblies, and methods for use in aquatic environments, it will be appreciated that the ladders, ladder assemblies, and methods in accordance with the present disclosure can be used with other types of structures and/or applications (e.g. hunting stands and other types of stands, non-aquatic platforms, vehicles, trains, airplanes, other types of elevated structures, steps, etc.) in which an animal is to accompany an individual or the animal uses by itself.

Advantages of the disclosed technology include the following: (i) the ladder assembly can be collapsed into a portable configuration; (ii) the ladder assembly is easy and convenient to use; (iii) the ladder assembly is light weight and convention to use, store, and transport; (iv) the ladder assembly can easily be affixed and deployed to an accompanying structure; (v) the ladder assembly can easily be detached from an accompanying structure; (vi) the ladder assembly optionally includes a mounting bracket that can be adjusted to accommodate gunnels, lips, edges, hulls, platforms, etc. having varying sizes; (vii) the mounting bracket, when used, can optionally include one or more pads that mitigate damage to the accompanying structure to which it is affixed.

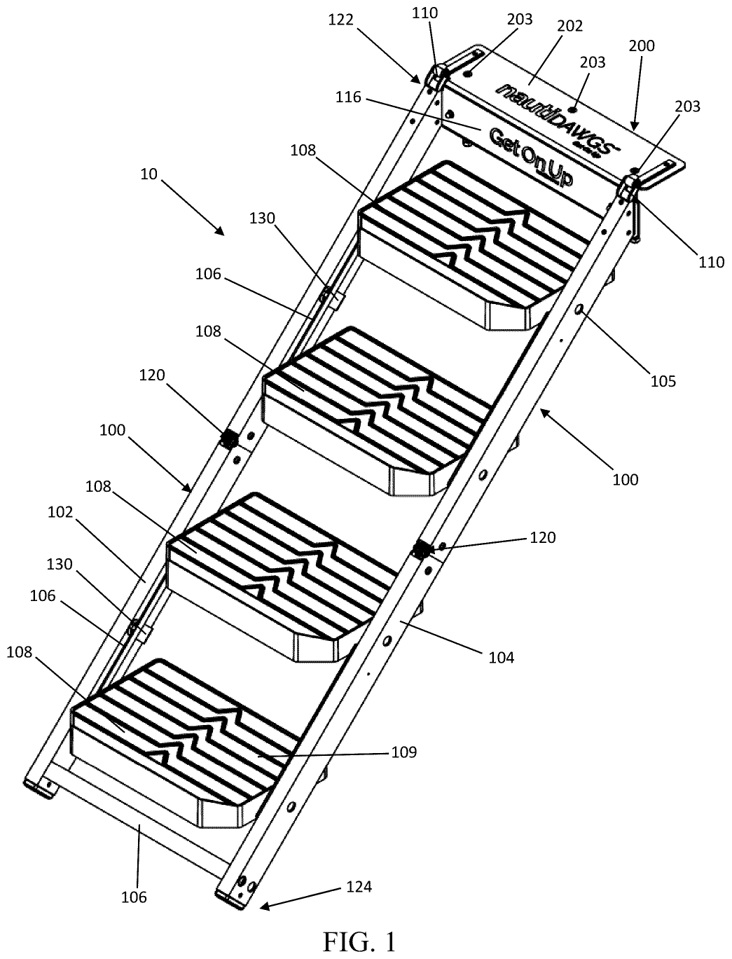

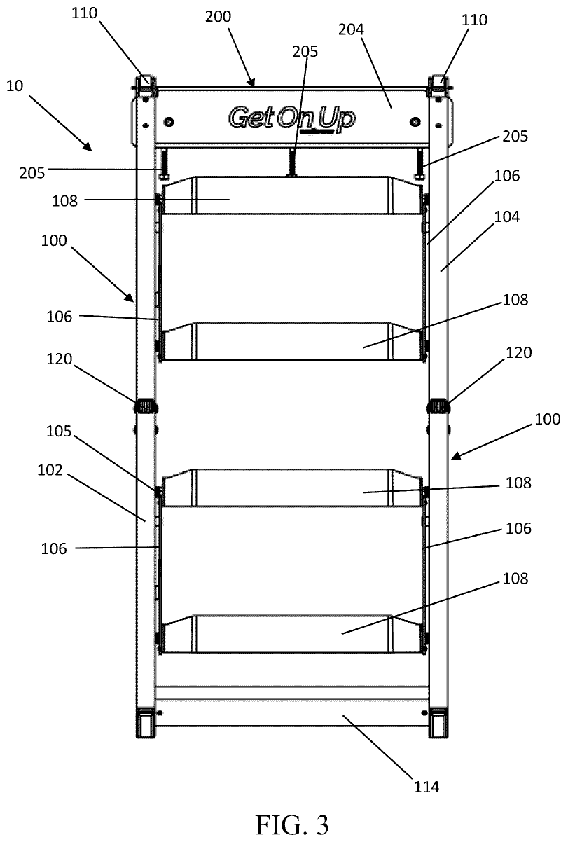

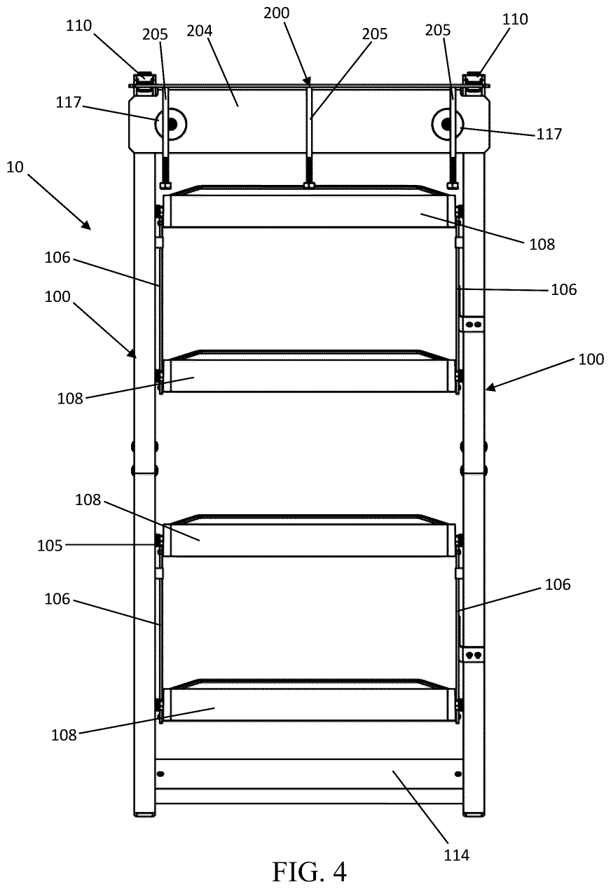

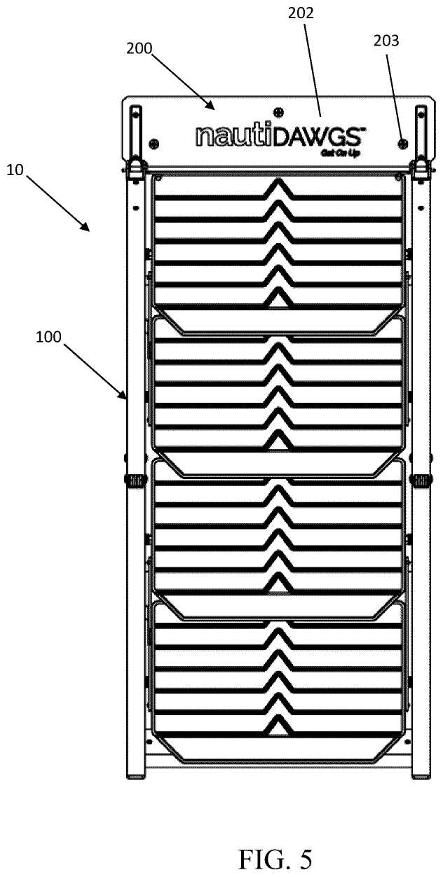

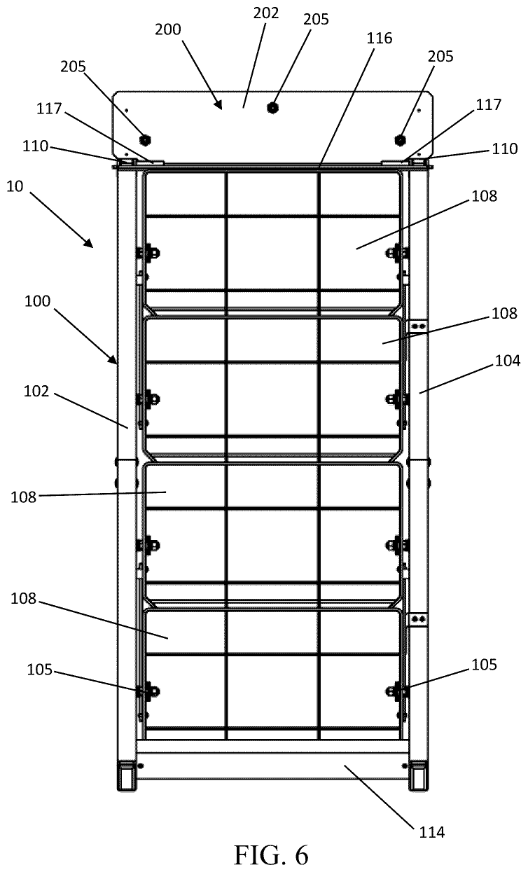

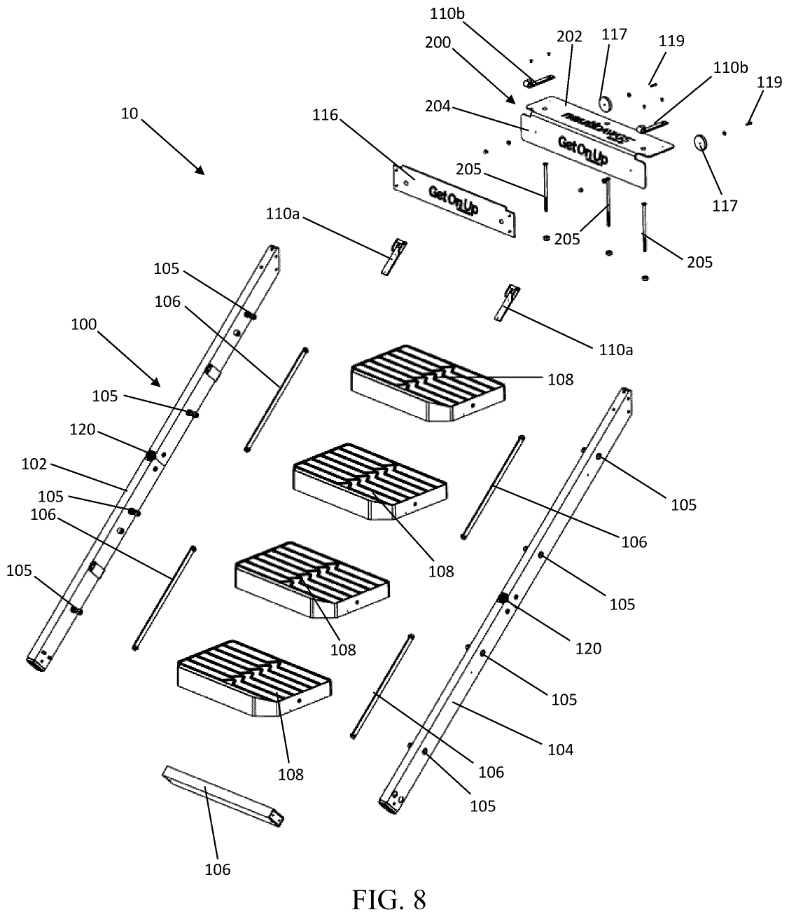

Referring now to FIGS. 1-8, wherein is illustrated one nonlimiting ladder assembly/system comprising a non-limiting ladder and a non-limiting mounting bracket. FIGS. 1-4 depict the ladder assembly/system in the fully assembled and extended configuration. FIGS. 5-6 depict the steps of the ladder assembly/system of FIGS. 1-4 in the folded orientation.

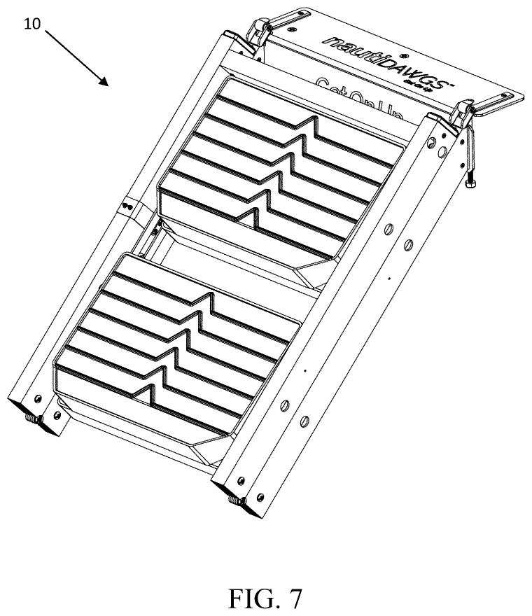

With reference to FIG. 1, disclosed is a non-limiting ladder assembly/system 10. The ladder assembly/system 10 comprises a ladder 100 and a mounting bracket 200. The non-limiting ladder assembly/system 10 can advantageously transition between an extended orientation (see for example FIGS. 1-4), a partially collapsed orientation (See FIGS. 5-6), and a fully collapsed orientation (see for FIG. 7), or vice versa. In the fully collapsed configuration, the ladder assembly/system 10 is in a substantially reduced profile such that the ladder assembly/system 10 can be easily transported, stored, and/or reduced in overall length. The material used to form the ladder assembly/system 10 is non-limiting (e.g., metal, wood, fiberglass or other fiber composite materials, plastic, ceramic, rubber, foam, polymer materials, etc.).

Now referring to FIGS. 1-4, the ladder 100 comprises a first end 122 and a second end 124; and the ladder 100 further comprises a first ladder arm 102 extending between the first and second ends 122, 124, a second ladder arm 104 extending between the first and second ends 122, 124 and extending opposite the first ladder arm 102. The first and second ladder arms can be generally parallel to one another along 50-100% (and all values and ranges therebetween) the longitudinal length of the ladder 100. The first and second arms can optionally have the same size, shape and/or configuration, and/or be formed of the same materials.

A plurality of step arms 106 and a plurality of steps 108 are positioned between the first and second ladder arms 102, 104. The plurality of steps 108 are rotatable or pivotally connected to the first and second ladder arms 102, 104 so that the steps 108 can move between the folded and unfolded orientation. A connection arrangement 105 can be used to connect the steps 108 to the first and second ladder arms 102, 104. The connection arrangement is non-limiting (e.g., bushing, rod, screw, clip, pin, etc.).

One or more hinge clips 110, a cross bar 114, and/or a cross plate 116 can optionally be included on the ladder 100.

In one non-limiting embodiment, the first and second ladder arms 102, 104 each optionally include one or more ladder hinges 120 that are configured to pivot and/or transition the ladder 100 and the first and second ladder arms 102, 104 between an extended orientation and a collapsed or fully folded orientation.

In one non-limiting embodiment, one or more of all of the plurality of steps 108 can fold inward into a closed or folded position (See FIGS. 5-6) such that one or more or each of the plurality of steps 108 are substantially parallel with the first and second ladder arms 102, 104 (e.g., ±0-10° from parallel with the first and second ladder arms 102, 104).

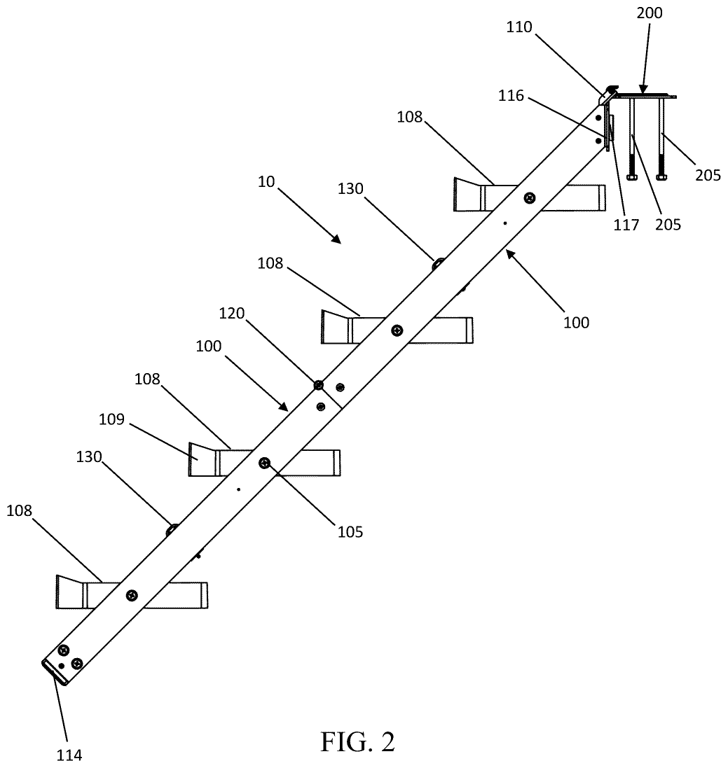

In one non-limiting embodiment, the steps can be formed of the same or different material from the first and second ladder arms 102, 104. In one non-limiting embodiment, the steps are formed of metal, plastic, wood, fiberglass or other types of fiber material. The shape, configuration, size and/or material of each of the steps can optionally be the same. The top surface of one or more of the steps can optionally include a gripping surface 109 to inhibit or prevent slippage on the top surface of the steps. Such gripping surface is non-limiting (e.g., rubber top surface, rubber strips on top surface, rough top surface, top surface that includes one or more openings, grooves, ridges, slots, etc.). As illustrated in FIG. 2, the front portion of one or more of the steps can optionally include an upwardly sloping portion. Such upwardly sloping portion can be used to facilitate in the transversing of the steps by a human and/or animal.

One or more step clips 130 can optionally be used use with the ladder of FIG. 1. The one or more optional side clips 130 can be configured for use with the ladder of FIG. 1 to facilitate in maintaining the orientation of one or more of the steps 108. The one or more step clips 130 can optionally be disposed along an inner facing portion of one or both of the first and second ladder arms 102, 104; however, the one or more step clips 130 can be located in other regions on the first and/or second ladder arms 102, 104. In one non-limiting embodiment, the one or more step clips 130 are configured to facilitate in holding one or more or all of the plurality of steps 108 in an open position or unfolded position (see for example FIG. 1) and/or in a closed position or folded position (see for example FIG. 5). As discussed above, one or more or all of the steps 108 are pivotally or rotatably connected to the first and second ladder arms 102, 104 by one or more connection arrangements 105. Also, when one or more of the step arms 106 are used, each of the step arms is connected to at least one, and typically at least two adjacently positioned steps 108. The step arms are generally pivotally or rotatably or slidably connected to the steps 108. The type of connection used is non-limiting (e.g., rod or pin connection, hinge connection, slot connection, etc.). In one non-limiting embodiment, at least one step clip 130, when used, is configured to releasable engage one or more step arms 106. The one or more step clips can optionally include a tab portion at the top region of the step clip 130 to enable a user to easily grasp a portion of the step clip 130 and cause the step clip to move into and out of engagement with one or more of the step arms 106. In one non-limiting configuration, one or more of the step clips can be configured to be 1) pushed toward the first or second arms to cause the step clip to disengage from a portion or all of one or more step arms to allow the step arms to move relative to the step clip to enable one or more steps to move between the folded and unfolded position, or 2) pulled away from the first or second arms to cause the step clip to disengage from a portion or all of one or more step arms to allow the step arms to move relative to the step clip to enable one or more steps to move between the folded and unfolded position. The one or more step clips can optionally include a flange portion, a groove, a ridge, etc. that is configured to engage one or more portions of the step arms to inhibit or prevent movement of the steps arms relative to the step clip when the step clip is in engagement with the step arm. The shape of the one or more step arms is non-limiting. In one non-limiting configuration, the cross-sectional shape along 1-100% (and all values and ranges therebetween) of the longitudinal length of the step arm is circular, oval, square, rectangular, triangular, star-shaped, or polygonal. A top region of the step clip 130 can optionally include a raised flange portion that is configured to be pushed toward the first or second arms to cause the step clip 130 to disengage from one or more step arms 106 (e.g., having a rectangular or square cross-sectional shape) to allow the step arm 106 to move relative to the step clip 130, and wherein when the step clip 130 reengages the step arm, the flange, when used, on the step clip 130 inhibits or prevents the step arm 106 from moving relative to the step clip. The step clip can be optionally configured such that the step clip does not engage the step arm 106 to inhibit or prevent the step arm 106 from moving relative to the step clip until the step 108 to which the step arm 106 is connected is moved to 75-100% (and all values and ranges therebetween) of the fully open or unfolded portion or the collapsed or fully folded position. The step clip 130 can be optionally connected to the first or second ladder arms 102, 104 by a flex connection (e.g., moves to a disengagement position when force is applied to the step clip and then moves back into an engagement position when force is removed from the step clip), a hinge connection, spring or biasing arrangement and hinge connection, a clip connection, a rachet connection, magnet connection, etc.

In another non-limiting embodiment, cross plate 116 is configured to be connected to the top or top portion of the first and second ladder arms 102, 104, and cross bar 114 is configured to be connected to the bottom or bottom portion of the first and second ladder arms 102, 104 to provide structural strength and/or rigidity to the ladder 100. The size, configuration, shape and material of the cross plate 116 and cross bar 114 are non-limiting. Generally, the cross plate 116 and cross bar 114 are rigidly connected to the first and second ladder arms 102, 104.

The ladder 100 can optionally include one or more hinge clips 110. In one non-limiting embodiment, the one or more hinge clips 110 are coupled at or near the first end 122 of the ladder 100. The one or more hinge clips are configured to be detachably connected to the mounting bracket. In one non-limiting configuration, the one or more hinge clips 110 are coupled to the first and/or second ladder arms 102, 104, and/or to the cross plate 116. In another non-limiting embodiment, the one or more hinge clips 110 can optionally be configured to removably couple to the mounting bracket 200. The one or more hinge clip can be formed of metal, plastic, fiberglass or other fiber composite, fabric, etc. The hinge clips 110 can include a hinge portion that is formed of a hinge, flexible plastic, flexible fabric material, etc. As can be appreciated, the one or more hinge clips can optionally be coupled to the mounting bracket, and be configured to be detachably connected to the ladder. In one non-limiting embodiment, the hinge clip 110 can optionally include a first and second portion 110a, 110b that can optionally be releasably connected together. The connection can be such that the first and second portion 110a, 110b can pivot respect to one another. In one non-limiting configuration, when the hinge clip first and second portions are disconnected from one another, the ladder 100 is disconnected from the mounting bracket 200, and when the hinge clip first and second portions are connected together, the ladder 100 is connected to mounting bracket 200.

Referring now to FIGS. 1, 2, 4, 5 and 6, there is a non-limiting mounting bracket 200 for use with the ladder 100 as illustrated in FIG. 1. The mounting bracket 200 comprises a front plate 202 and a back plate 204. The mounting bracket 200 is an angled plate (e.g., plate having a L-shaped cross-sectional shape, etc.), wherein the first plate 202 is substantially perpendicular (e.g., 80-110° and all values and ranges therebetween) to the back plate 204. The hinge clips 110 are illustrated as connected to the front plate 202 and the first and second ladder arms 102, 104 or the cross plate 116. The type of arrangement used to connect the hinge clips to the front plate and first and second ladder arms is non-limiting (e.g., adhesive, screw, bolt, rivet, clamp, weld, melted connection, etc.). The front plate includes a plurality of openings 203 that are used to receive a connector 205 (e.g., screw, bolt, rivet, etc.) so as to connect the mounting bracket to a structure (e.g., gunnels, lips, edges, hulls, platforms, etc.).

The inner surface of the back plate 204 of the mounting bracket can optionally include one or more front pads 117 (e.g., rubber, polymeric material, etc.) that are coupled to the back plate 204. The one or more front pads can be used to protect the structure to which the ladder assembly 10 is attached thereto from damage. As can be appreciated, other or additional can include materials can be used to facilitate in inhibiting or prevent damage to a structure to which the ladder assembly is connected thereto. The one or more front pads 117 can be connected to the back plate 204 by one or more arrangements 119 (e.g., adhesive, screw, bolt, rivet, clamp, etc.).

In one non-limiting methodology for attaching/affixing the ladder assembly/system 10 to a gunnels, lips, edges, hulls, platforms, etc., the following steps can optionally be performed: (i) the mounting bracket 200 is placed on a gunnels, lips, edges, hulls, platforms, etc. and connected to the gunnel, lip, edge, hull, platform, etc.; (ii) the one or more hinge clips 110 are pivoted to deploy the ladder assembly/system 10 to a desired position; and (iii) the ladder assembly/system 10, if not already unfolded, is then unfolded into its extended configuration. It will be appreciated that any of a variety of additional or alternative steps may be included in a method of attaching the ladder assembly/system 10.

In one non-limiting methodology for detaching/dissembling the ladder assembly/system 10 from the gunnels, lips, edges, hulls, platforms, etc., the following steps are performed: (i) the ladder assembly/system 10 is optionally folded/collapsed into its collapsed configuration; and (ii) the mounting bracket is disengaged from the gunnels, lips, edges, hulls, platforms, etc. It can be appreciated that the mounting bracket can remain connected to the gunnels, lips, edges, hulls, platforms, etc. In such an arrangement, a portion of the hinge clip 110 can be disconnected from the mounting bracket 200 and/or the first and second ladder arms 102, 104 so that the ladder 100 can be removed from the gunnels, lips, edges, hulls, platforms, etc.

It will be appreciated that any of a variety of additional or alternative steps may be included in a method of detaching the ladder assembly/system 10.

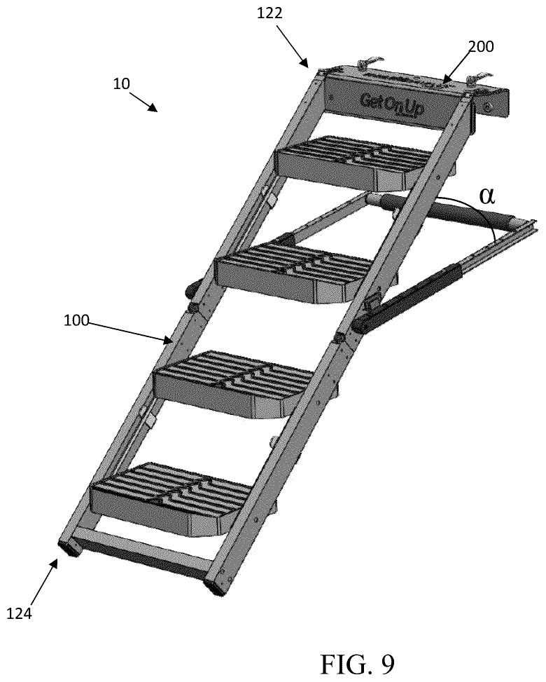

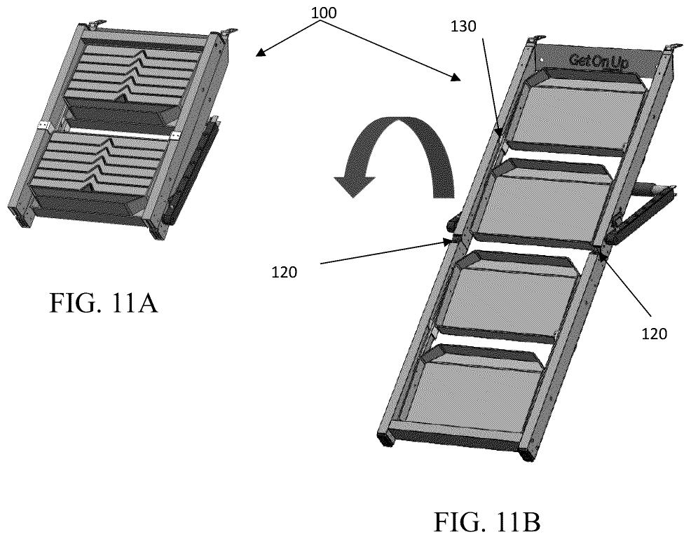

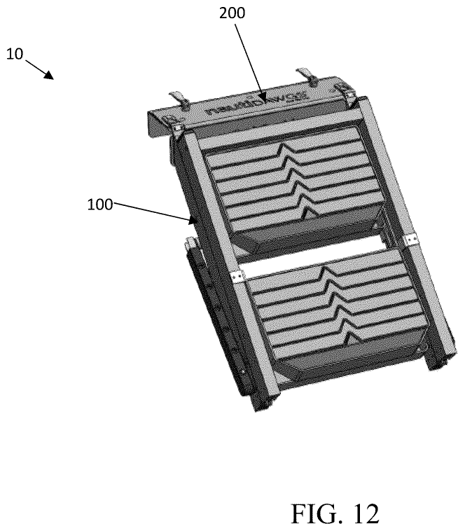

Referring now to FIGS. 9-17, wherein is illustrated one nonlimiting ladder assembly/system comprising a non-limiting ladder and a non-limiting mounting bracket. FIG. 9 depicts the ladder assembly/system in the fully assembled and extended orientation. FIG. 11B depicts the steps of the ladder assembly/system of FIG. 1 in the folded orientation. FIGS. 11A and 12 depict the ladder assembly/system in the fully folded or collapsed orientation.

With reference to FIG. 9, disclosed is another non-limiting ladder assembly/system 10. The ladder assembly/system 10 comprises a ladder 100 and a mounting bracket 200. The non-limiting ladder assembly/system 10 can advantageously transition between an extended orientation (see for example FIG. 9) and a collapsed orientation (see for example FIGS. 11A and 12), or vice versa. In the collapsed configuration, the ladder assembly/system 10 is in a substantially reduced profile such that the ladder assembly/system 10 can be easily transported, stored, and/or reduced in overall length. The material used to form the ladder assembly/system 10 is non-limiting (e.g., metal, wood, fiberglass or other fiber composite materials, plastic, ceramic, rubber, foam, polymer materials, etc.).

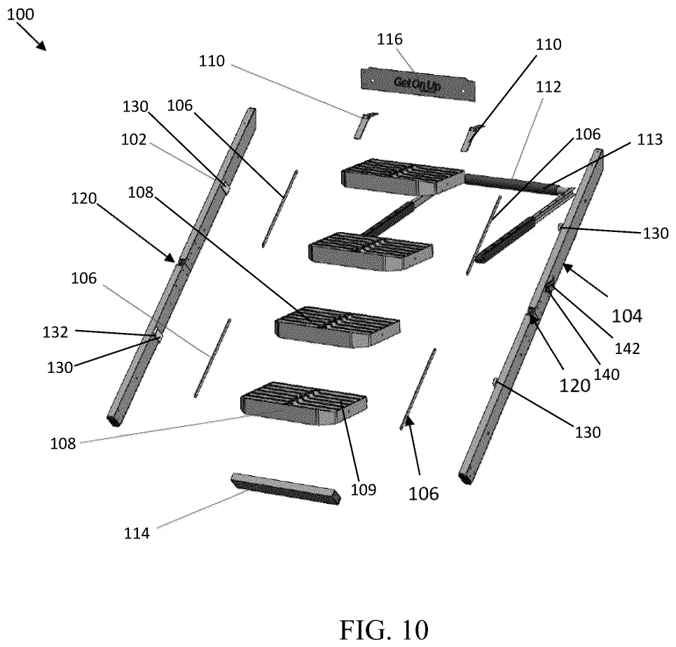

Now referring to FIGS. 9-10, the ladder 100 comprises a first end 122 and a second end 124; and the ladder 100 further comprises a first ladder arm 102 extending between the first and second ends 122, 124, a second ladder arm 104 extending between the first and second ends 122, 124 and extending opposite the first ladder arm 102. The first and second ladder arms can be generally parallel to one another along 50-100% (and all values and ranges therebetween) the longitudinal length of the ladder 100. The first and second arms can optionally have the same size, shape and/or configuration, and/or be formed of the same materials.

A plurality of step arms 106 and a plurality of steps 108 are positioned between the first and second ladder arms 102, 104. The plurality of steps 108 are rotatable or pivotally connected to the first and second ladder arms 102, 104 so that the steps 108 can move between the folded and unfolded orientation.

One or more hinge clips 110, a stability arm 112, a cross bar 114, and/or a cross plate 116 can optionally be included on the ladder 100.

In one non-limiting embodiment, the first and second ladder arms 102, 104 each optionally include one or more ladder hinges 120 that are configured to pivot and/or transition the ladder 100 and the first and second ladder arms 102, 104 between an extended orientation and a collapsed or fully folded orientation (see for example FIGS. 11A, 11B, 12). The arrow in FIG. 11B is representative as to how the ladder 100 and the first and second ladder arms 102, 104 can be folded from the extended orientation to the collapsed or fully folded orientation.

In one non-limiting embodiment, one or more of all of the plurality of steps 108 can fold inward into a closed or folded position such that one or more or each of the plurality of steps 108 are substantially parallel with the first and second ladder arms 102, 104 (e.g., +0-10° from parallel with the first and second ladder arms 102, 104) (see for example FIG. 11B).

In one non-limiting embodiment, the steps can be formed of the same or different material from the first and second ladder arms 102, 104. In one non-limiting embodiment, the steps are formed of metal, plastic, wood, fiberglass or other types of fiber material. The shape, configuration, size and/or material of each of the steps can optionally be the same. The top surface of one or more of the steps can optionally include a gripping surface 109 to inhibit or prevent slippage on the top surface of the steps. Such gripping surface is non-limiting (e.g., rubber top surface, rubber strips on top surface, rough top surface, top surface that includes one or more openings, grooves, ridges, slots, etc.)

One or more step clips 130 can optionally be used use with the ladder of FIG. 9. The one or more optional side clips 130 can be configured for use with the ladder of FIG. 9 to facilitate in maintaining the orientation of one or more of the steps 108. The one or more step clips 130 can optionally be disposed along an inner facing portion of one or both of the first and second ladder arms 102, 104; however, the one or more step clips 130 can be located in other regions on the first and/or second ladder arms 102, 104. In one non-limiting embodiment, the one or more step clips 130 are configured to facilitate in holding one or more or all of the plurality of steps 108 in an open position or unfolded position (see for example FIG. 9) and/or in a closed position or folded position (see for example FIG. 11B). As discussed above, one or more or all of the steps 108 are pivotally or rotatably connected to the first and second ladder arms 102, 104. The type of connection used is non-limiting (e.g., rod or pin connection, hinge connection, etc.). Also, when one or more of the step arms 106 are used, each of the step arms is connected to at least one, and typically at least two adjacently positioned steps 108. The step arms are generally pivotally or rotatably or slidably connected to the steps 108. The type of connection used is non-limiting (e.g., rod or pin connection, hinge connection, slot connection, etc.). In one non-limiting embodiment, at least one step clip 130, when used, is configured to releasable engage one or more step arms 106. The one or more step clips can optionally include a tab portion at the top region of the step clip 130 to enable a user to easily grasp a portion of the step clip 130 and cause the step clip to move into and out of engagement with one or more of the step arms 106. In one non-limiting configuration, one or more of the step clips can be configured to be 1) pushed toward the first or second arms to cause the step clip to disengage from a portion or all of one or more step arms to allow the step arms to move relative to the step clip to enable one or more steps to move between the folded and unfolded position, or 2) pulled away from the first or second arms to cause the step clip to disengage from a portion or all of one or more step arms to allow the step arms to move relative to the step clip to enable one or more steps to move between the folded and unfolded position. The one or more step clips can optionally include a flange portion, a groove, a ridge, etc. that is configured to engage one or more portions of the step arms to inhibit or prevent movement of the steps arms relative to the step clip when the step clip is in engagement with the step arm. The shape of the one or more step arms is non-limiting. In one non-limiting configuration, the cross-sectional shape along 1-100% (and all values and ranges therebetween) of the longitudinal length of the step arm is circular, oval, square, rectangular, triangular, star-shaped, or polygonal. As illustrate in FIG. 10, a top region of the step clip 130 includes a raised flange portion 132 that is configured to be pushed toward the first or second arms to cause the step clip 130 to disengage from one or more step arms 106 (e.g., having a rectangular or square cross-sectional shape) to allow the step arm 106 to move relative to the step clip 130, and wherein when the step clip 130 reengages the step arm, the flange 132 on the step clip 130 inhibits or prevents the step arm 106 from moving relative to the step clip. The step clip can be optionally configured such that the step clip (e.g., flange 132, etc.) does not engage the step arm 106 to inhibit or prevent the step arm 106 from moving relative to the step clip until the step 108 to which the step arm 106 is connected is moved to 75-100% (and all values and ranges therebetween) of the fully open or unfolded portion or the collapsed or fully folded position. The step clip 130 can be optionally connected to the first or second ladder arms 102, 104 by a flex connection (e.g., moves to a disengagement position when force is applied to the step clip and then moves back into an engagement position when force is removed from the step clip), a hinge connection, spring or biasing arrangement and hinge connection, a clip connection, a rachet connection, magnet connection, etc.

In another non-limiting embodiment, the ladder 100 optionally includes one or more side clips 140 (See FIG. 10) disposed along an exterior facing portion of one or both of the first and second ladder arms 102, 104. In one non-limiting embodiment, the one or more side clips 140 are configured to cooperate with and/or engage the optional stability arm 112 to hold the stability arm 112 at a predetermined angle, position, location, height, and/or distance. The stability arm is an optional component of the ladder 100. As such, if the stability arm is absent from the ladder, then the one or more side clips 140 can also be eliminated from the ladder.

The stability arm 112, when used, if configured to provide support to the first and second ladder arms 102, 104 when an animal or human is moving up or down the steps 108 when the ladder 100 is connected to a structure. The stability arm is configured to move between an unfolded orientation (See FIG. 9), and a folded orientation (See FIG. 11A). The connection arrangement used to connect the stability arm 112 to the first and second ladder arms 102, 104 is non-limiting (e.g., (e.g., rod or pin connection, hinge connection, screw connection, bolt connection, etc.). When the stability arm 112 is in the unfolded orientation, a portion of the stability arm can be configured to engage a structure to which the ladder assembly is connected to maintain a distance of the first and second ladder arms 102, 104 of the ladder 100 when an animal or human is moving up or down the steps 108. As illustrated in FIG. 9, the angle α that the stability arm 112 is orientated to first and second ladder arms 102, 104 of the ladder 100 when the stability arm 112 is in the unfolded orientation is 5-90° (and all values and ranges therebetween). When stability arm 112 is in the folded orientation, the angle α that the stability arm 112 is orientated to first and second ladder arms 102, 104 of the ladder 100 is 0-10° (and all values and ranges therebetween) or 170-180° (and all values and ranges therebetween), depending on if the stability arm 112 is folded up or down on the first and second ladder arms 102, 104.

In one non-limiting embodiment, the one or more side clips 140 can optionally include an engagement portion 142 (which engagement portion is optionally biased in a position by a spring, etc.). In one non-limiting embodiment, the engagement portion 142 is optionally configured to tuck or otherwise move out of engagement with the stability arm 112 when the stability arm 112 is folded and/or pivoted across the one or more side clips 140 when the stability arm is moved between the collapsed or fully folded position to the open or fully unfolded position. In one non-limiting embodiment, the one or more side clips only inhibit or prevent movement of the stability arm in at least one direction relative to the first and second ladder arms 102, 104 when the stability arm is in the open or fully unfolded position. In one non-limiting configuration, when the stability arm is in the open or fully unfolded position, the engagement portion is configured to engage at least a portion of the stability arm 112 to inhibit or prevent further unfolding of the stability arm 112. In another non-limiting configuration, the engagement portion 142 can be configured to move from a compressed to an uncompressed position (e.g., via the biasing arrangement, etc.) and engages a portion of the stability arm to inhibit or prevent the stability arm from moving from the open or fully unfolded position to the collapsed or fully folded position. When the stability arm is to be moved to the collapsed or fully folded position, a user causes the engagement portion 142 to move to the compressed position (e.g., user presses again the engagement portion to move it to the compressed position, etc.) there allowing the stability arm to be moved relative to the first and second ladder arms 102, 104 to the collapsed or fully folded position.

In one non-limiting embodiment, the stability arm 112 an optionally include a protecting coating, protective sleeve, padding and/or foam 113 to a) inhibit or prevent damage by the stability arm 112 to a structure (e.g., boat, etc.) when the stability engages a structure during use of the ladder, and/or b) facilitate in the gripping of or non-slipping of the stability arm with a structure during use of the ladder. The material of the padding and/or foam 113 is non-limiting (e.g., polymer foam, rubber, plastic, etc.). The padding and/or foam 113 can be located on a portion or all of the stability arm 112.

In another non-limiting embodiment, the stability arm 112 can optionally be a generally U-shaped structure formed of first and second side arms and a middle bar connected therebetween; however, other shapes can be used. In such configuration, the end portion of the two arms of the U-shaped structure are pivotally or rotatably connected to the first and second ladder arms 102, 104. The portion of the stability arm 112 between the two arms is configured to engage a structure and support the ladder when in use. In one non-limiting configuration, when the stability arm is a U-shaped structure, the length of the first and second side arms are each 10-50% (and all values and ranges therebetween) the longitudinal length of the first or second ladder arms 102, 104. In another non-limiting configuration, the first and second side arms are positioned generally parallel to one another. In another non-limiting configuration, the middle bar is liner shaped or curved shaped along 50-100% (and all values and ranges therebetween) the longitudinal length of the middle bar. In another non-limiting configuration, the first and second side arms are liner shaped along 50-100% (and all values and ranges therebetween) the longitudinal length of the first and second side arms.

In another non-limiting embodiment, cross plate 116 is configured to be connected to the top or top portion of the first and second ladder arms 102, 104, and cross bar 114 is configured to be connected to the bottom or bottom portion of the first and second ladder arms 102, 104 to provide structural strength and/or rigidity to the ladder 100. The size, configuration, shape and material of the cross plate 116 and cross bar 114 are non-limiting. Generally, the cross plate 116 and cross bar 114 are rigidly connected to the first and second ladder arms 102, 104.

The ladder 100 can optionally include one or more hinge clips 110. In one non-limiting embodiment, the one or more hinge clips 110 are coupled at or near the first end 122 of the ladder 100. The one or more hinge clips are configured to be detachably connected to the mounting bracket. In one non-limiting configuration, the one or more hinge clips 110 are coupled to the first and/or second ladder arms 102, 104, and/or to the cross plate 116. In another non-limiting embodiment, the one or more hinge clips 110 can optionally be configured to removably couple to the mounting bracket 200. The one or more hinge clip can be formed of metal, plastic, fiberglass or other fiber composite, fabric, etc. The hinge clips 110 can include a hinge portion that is formed of a hinge, flexible plastic, flexible fabric material, etc. As can be appreciated, the one or more hinge clips can optionally be coupled to the mounting bracket, and be configured to be detachably connected to the ladder.

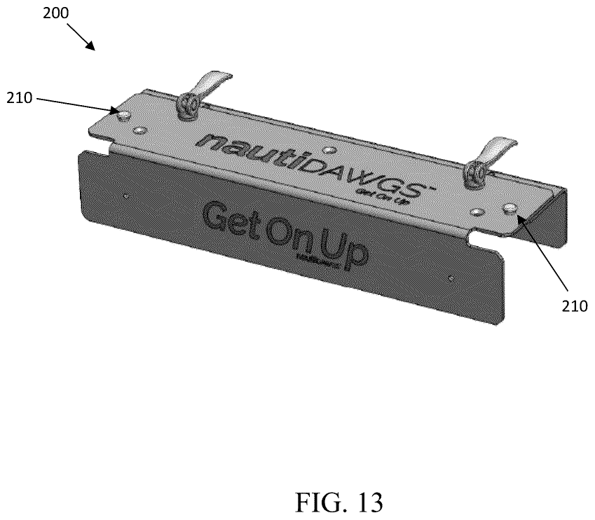

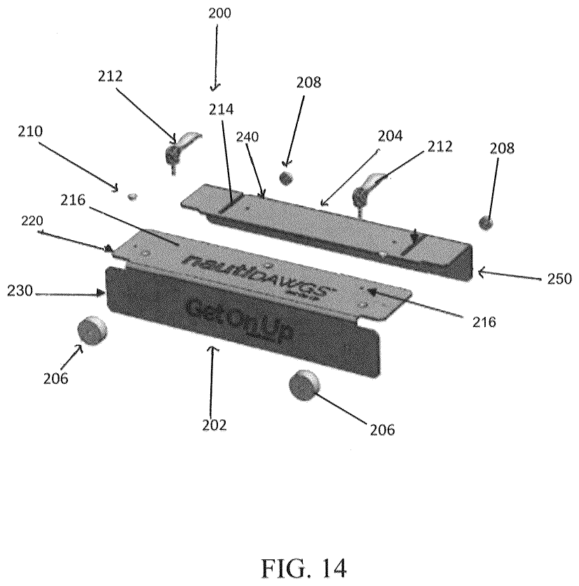

Referring now to FIG. 13, there is a perspective view of one non-limiting mounting bracket 200 for use with the ladder illustrated in FIG. 9. FIG. 14 is an exploded view of the mounting bracket 200 of FIG. 13.

Now referring to FIGS. 13-17, in one non-limiting embodiment, the mounting bracket 200 comprises a front plate 202, a back plate 204, optionally one or more front pads 206 coupled to the front plate 202, optionally one or more back pads 208 coupled to the back plate 204, one or more attachment lugs 210 coupled to the front plate 202, and one or more clamping handles 212. In the present non-limiting embodiment, the back plate 204 includes one or more channels 214 formed therein that are configured to receive a) at least a portion of the one or more clamping handles 212, or b) a structure that slidably engages the channels 214. In the present non-limiting embodiment, the one or more clamping handles 212 engage one or more holes 216 formed in the front plate 202 and subsequently engage the one or more channels 214 of the back plate 204, thereby moveably coupling the front plate 202 to the back plate 204. When the clamping handle in the non-locked orientation, the front and back plates can move relative to one another to adjust the width between the side arms of the front plate 202 to the back plate 204. When the clamping handle in the locked orientation, the front and back plates are inhibited or prevented from moving relative to one another so as to lock the distance between the side arms of the front plate 202 to the back plate 204. As can be appreciated, other arrangements can be used to adjust and lock the front and back plates relative to one another.

In the present non-limiting embodiment, the back plate 204 optionally includes a rubber (or similar polymeric material) stopper 280 that protects the structure to which the mounting bracket 200 is attached thereto from damage. In one non-limiting embodiment, the front plate 202 includes the stopper 280. As can be appreciated, other or additional surface of the mounting bracket can include materials that are used to facilitate in inhibiting or prevent damage to a structure to which the mounting bracket is connected thereto.

Still referring to FIGS. 13-17, the front plate 202 is an angled plate (e.g., plate having a L-shaped cross-sectional shape, etc.) having a first portion 220 and a second portion 230, wherein the first portion 220 is substantially perpendicular (e.g., 80-110° and all values and ranges therebetween) to the second portion 230. In one non-limiting embodiment, the back plate 204 is an angled plate (e.g., plate having a L-shaped cross-sectional shape, etc.) having a first portion 240 and a second portion 250, wherein the first portion 240 is substantially perpendicular (e.g., 80-110° and all values and ranges therebetween) to the second portion 250. It is to be appreciated that various angles are possible between the first portion 220 and a second portion 230, and the first portion 240 and the second portion 250.

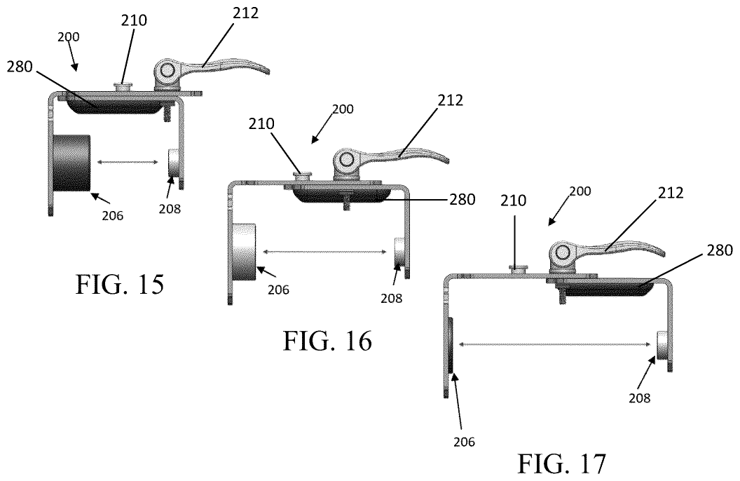

FIGS. 15-17 depict various adjustment distances of the mounting bracket of FIG. 13, wherein FIG. 15 depicts an exemplary minimum adjustment distance, wherein FIG. 16 depicts an exemplary standard or average adjustment distance, and wherein FIG. 17 depicts an exemplary maximum adjustment distance. With reference to 15, in one non-limiting embodiment, one or more of the front pads 206 has a width of about 1 inch, and the distance between the one or more front pads 206 and the one or more back pads 208 is about 2 inches. FIG. 15 depicts an exemplary, non-limiting minimum adjustment distance to accommodate small gunnels, lips, edges, hulls, platforms, etc., meaning that the mounting bracket 200 in FIG. 15 can be coupled to gunnels, lips, edges, hulls, platforms, etc. having a width no less than about 2 inches. As can be appreciated, these distances merely exemplary, not limiting. As illustrated in FIGS. 15-17, the size/width of the front pads 206, back pads 208 can be selected to also change the maximum and minimum distance between the one or more front pads 206 and the one or more back pads 208. The gap formed by the mounting bracket, in combination with the optional pads, can be adjusted to properly secure the mounting bracket to a structure.

With reference to FIG. 16, one or more of the front pads 206 has a width of about ½ inch, and the distance between the one or more front pads 206 and the one or more back pads 208 is variable and can be any desired distance. With reference to FIG. 17, in one non-limiting embodiment, one or more of the front pads 206 has a width of about ⅛ inch, and the distance between the one or more front pads 206 and the one or more back pads 208 is about 5.5 inches. FIG. 17 depicts an exemplary, non-limiting maximum adjustment distance to accommodate large gunnels, lips, edges, hulls, platforms, etc., meaning that the mounting bracket 200 in FIG. 17 can be coupled to gunnels, lips, edges, hulls, platforms, etc. having a width no greater than about 5.5 inches; however, other widths can be used. With reference to FIGS. 15-17, in one non-limiting embodiment, the one or more front pads 206 can have a width between about ⅛ inch-1 inch (and all values therebetween); however, other widths can be used.

In one non-limiting methodology for attaching/affixing the ladder assembly/system 10 to a gunnels, lips, edges, hulls, platforms, etc., the following steps can optionally be performed: (i) the assembled mounting bracket 200 is placed on a gunnels, lips, edges, hulls, platforms, etc. such that one or more of the front pads 206 engage a first surface 22 of the gunnels, lips, edges, hulls, platforms, etc.; (ii) the one or more clamping handles 212 are tightened until the one or more back pads 208 engage a second surface 24 of the gunnels, lips, edges, hulls, platforms, etc., thereby securing the mounting bracket 200 to the gunnels, lips, edges, hulls, platforms, etc.; (iii) while the ladder 100 is optionally in its collapsed configuration, the one or more hinge clips 110 engage the one or more attachment lugs 210 of the mounting bracket 200 by inserting a portion of the attachment lugs through an opening in the mounting bracket, thereby attaching the ladder 100 to the mounting bracket 200; (iv) the one or more hinge clips 110 are pivoted to deploy the ladder assembly/system 10 to a desired position; (v) the ladder assembly/system 10, if not already unfolded, is then unfolded into its extended configuration; and (vi) the stability arm 112, when used or included on the ladder, can be optionally folded or pivoted outward to engage the first surface 22 of the gunnels, lips, edges, hulls, platforms, etc. It will be appreciated that any of a variety of additional or alternative steps may be included in a method of attaching the ladder assembly/system 10.

In one non-limiting methodology for detaching/dissembling the ladder assembly/system 10 from the gunnels, lips, edges, hulls, platforms, etc., the following steps are performed: (i) the stability arm 112, when use or included on the ladder, can be optionally folded or pivoted inward to disengage from the first surface of a gunnel, lip, edge, hull, platform, etc.; (ii) the ladder assembly/system 10 is optionally folded/collapsed into its collapsed configuration; (iii) the one or more hinge clips 110 are pivoted to disengage the ladder 100 from the mounting bracket 200; (iv) the one or more hinge clips 110 disengage from the one or more attachment lugs 210 of the mounting bracket 200 and the ladder 100 is separated from the mounting bracket 200; (v) subsequent to removing the ladder 100, the mounting bracket 200 can optionally remain affixed to the gunnels, lips, edges, hulls, platforms, etc. or the mounting bracket 200 can be removed; (vi) if the mounting bracket is to be removed, the one or more clamping handles 212 are loosened until the one or more back pads 208 disengage from the second surface 24 of the gunnels, lips, edges, hulls, platforms, etc.; (vii) the one or more front pads 206 can then be disengaged from the first surface 22 and the mounting bracket 200 can be removed from the gunnels, lips, edges, hulls, platforms, etc. It will be appreciated that any of a variety of additional or alternative steps may be included in a method of detaching the ladder assembly/system 10.

As can be appreciated mounting bracket can optionally be modified and/or configured for use with a non-limiting platform. In one non-limiting example, this configuration may be desired when there is no vertical edge or gunnel to which the mounting bracket 200 can be affixed. In this non-limiting embodiment, only the front plate 202 is coupled to the platform way of one or more fasteners (e.g. screws, nuts, bolts, lugs, etc.). In this non-limiting embodiment, the back plate 204 and/or the one or more clamping handles 212 are removed from the mounting bracket 200. In one non-limiting methodology for attaching/affixing the front plate 202 and the ladder 100 to a platform, etc., the following steps are performed: (i) the front plate 202 is fastened directly to the platform such that one or more of the optional front pads 206 optionally engage a first surface 52 of the platform; (ii) while the ladder 100 is optionally in its collapsed configuration, the one or more hinge clips 110 engage the one or more attachment lugs 210, thereby attaching the ladder 100 to the front plate 202; (iii) the one or more hinge clips 110 are pivoted to deploy the ladder assembly/system 10; (iv) the ladder assembly/system 10 is then un-folded, if not already unfolded, into its extended configuration; and (v) the stability arm 112, when used or included on the ladder, can be optionally folded or pivoted outward. It will be appreciated that any of a variety of additional or alternative steps may be included in a method of attaching the ladder assembly/system 10 to the platform.

In one non-limiting methodology for detaching/dissembling the ladder assembly/system 10 from the platform, the following steps are performed: (i) the stability arm 112, when used or included on the ladder, can be optionally folded or pivoted inward; (ii) the ladder assembly/system 10 is optionally folded/collapsed into its collapsed configuration; (iii) the one or more hinge clips 110 are pivoted to disengage the ladder 100 from the front plate 202; (iv) the one or more hinge clips 110 disengage from the one or more attachment lugs 210 and the ladder 100 is separated from the front plate 202; (v) subsequent to removing the ladder 100, the front plate 202 can optionally remain affixed to the platform or the front plate 202 can be removed; (vi) if the front plate 202 is to be removed, the one or more fasteners are removed from the front plate 202 and the one or more front pads 206 can then be disengaged from the first surface of the platform. It will be appreciated that any of a variety of additional or alternative steps may be included in a method of detaching/disassembling the ladder assembly/system 10 from the platform.

In another non-limiting embodiment, the mounting bracket 200 can be a monolithically formed structure that is configured to couple and/fasten to a gunnel, edge, etc., a platform. In such a configuration, the width of the mounting bracket is set, and can only be adjusted by use of one or more front and/or back pads.

As can be appreciated, the mounting bracket 200 and method of use as illustrated in FIGS. 9-17 and as described herein can be used with the ladder illustrated in FIGS. 1-8.

The stability arm 112, when optionally included on the ladder, can be optionally removed from the ladder 100. In one non-limiting embodiment, the stability arm 112 can be removed from the ladder 100 when the ladder 100 is to be used with a platform or other structure. One or more pins, screws, etc. can be removed to enable the stability arm 112 to be removed from the ladder.

It is to be appreciated that any of the disclosed components, attributes, and/or benefits can be used with any of the disclosed ladder assembly/systems.

In one non-limiting embodiment, the disclosed ladder assembly/systems may include a slip resistant material and/or coating (e.g. rubber, tape, treads, grit paint, runners, etc.) deposited on one or more of the steps. In one non-limiting embodiment, the disclosed ladder assembly/systems and its components can be formed from one or more metals, alloys, composite materials, and/or polymeric materials. In one non-limiting embodiment, the disclosed ladder assembly/systems and its components can include various graphical designs such as camouflage print and/or various color schemes.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall there between. The disclosure has been described with reference to the certain embodiments. These and other modifications of the disclosure will be obvious from the disclosure herein, whereby the foregoing descriptive matter is to be interpreted merely as illustrative of the disclosure and not as a limitation. It is intended to include all such modifications and alterations insofar as they come within the scope of the appended claims.

To aid the Patent Office and any readers of this application and any resulting patent in interpreting the claims appended hereto, Applicant does not intend any of the appended claims or claim elements to invoke 35 U.S.C. 112 (f) unless the words “means for” or “step for” are explicitly used in the particular claim.

What is claimed:

1. A ladder assembly comprising a ladder and a mounting bracket; said ladder is configured to releasably connect to said mounting bracket by a releasable connection arrangement; said mounting bracket is configured to connect to a structure to which said ladder assembly is to be connected thereto; said ladder includes a) a first ladder arm and a second ladder arm, b) a plurality of step arms, and c) a plurality of steps; said plurality of steps are rotatably positioned between said first and second ladder arms to enable said steps to move between a folded orientation and an unfolded orientation; each of said step arms are movable connected to two of said steps that are adjacently position to one another.

2. The ladder assembly as defined in claim 1, wherein said ladder includes a stability arm and a cross bar; said stability arm is rigidly connected to a lower portion of said first and second ladder arms to connect together said first and second ladder arms; said cross bar is rigidly connected to an upper portion of said first and second ladder arms to connect together said first and second ladder arms.

3. The ladder assembly as defined in claim 1, wherein each of said first and second ladder arms include a ladder hinge that is configured to enable said first and second ladder arms to pivot between an extended orientation and a folded orientation.

4. The ladder assembly as defined in claim 1, wherein said ladder includes a side clip; said side clip is configured to move to a first position that engage at least a portion of one of said step arms and a second position that disengages from at least one said step arms; and wherein when said side clip is in said first position said side clip inhibits or prevents said steps that are connected to said step arm from moving between said folded orientation and said unfolded orientation; and wherein when said side clip is in said second position to disengage from said step arm, said side clip allows said steps that are connected to said step arm to move between said folded orientation and said unfolded orientation.

5. The ladder assembly as defined in claim 4, wherein said side clip is movably connected to said first or second ladder arm.

6. The ladder assembly as defined in claim 1, wherein said mounting bracket comprises a front plate and a back plate that are connected together wherein said first plate is substantially perpendicular to said back plate.

7. The ladder assembly as defined in claim 1, wherein said mounting bracket includes one or more pads that are coupled to said front plate and/or said back plate.

8. The ladder assembly as defined in claim 1, wherein said ladder includes a stability arm; said stability arm is rotatably connected to said first and second ladder arms such that said stability arm is movable between a folded and unfolded position.

9. The ladder assembly as defined in claim 8, wherein said ladder includes one or more side clips positioned on one or both of said first and second ladder arms; each of said side clips is configured to engage at least a portion of said stability arm to hold said stability arm at a certain position relative to said first and/or second ladder arms.

10. The ladder assembly as defined in claim 9, wherein one or more of said side clips includes a biased member that move between an open and closed position; and wherein when said side clip is in said open position said side clip is configured to engage said stability arm and limit movement of said stability arm; and wherein when said side clip is in said closed position said side clip is configured to allow said stability arm to move past said side clip.

11. The ladder assembly as defined in claim 1, wherein said mounting bracket includes front plate, a back plate and a plate connection arrangement, and wherein said front and back plate are movably connected to one another; said plate connection arrangement is configured to releasably connect together said front and back plates so that the front and back plates are immovably connected together; and wherein said front and back plates form an adjustable connection gap that is used to connected said mounting bracket to the structure.

12. The ladder assembly as defined in claim 11, wherein at least one of said front and back plates includes one or more channels to facilitate in movement of said front and back plates relative to one another.

13. A method for facilitating in enable an animal to exit a body of water and access a structure surface located above a top surface of said body of water; said method comprises:
providing a ladder assembly; said ladder assembly comprising a ladder and a mounting bracket; said ladder is configured to releasably connect to said mounting bracket by a releasable connection arrangement; said mounting bracket is configured to connect to a structure to which said ladder assembly is to be connected thereto; said ladder includes a) a first ladder arm and a second ladder arm, b) a plurality of step arms, and c) a plurality of steps; said plurality of steps are rotatably positioned between said first and second ladder arms to enable said steps to move between a folded orientation and an unfolded orientation; each of said step arms are movable connected to two of said steps that are adjacently position to one another;
connecting said mounting bracket to a portion of said structure;
unfolding said ladder such that a bottom portion of said ladder is located closed adjacent to a top surface of said body of water or submerged in said body of water;
unfolding said plurality of steps to said unfolded orientation; and
allowing said animal to climb said plurality of steps so that said animal can exit said body of water and access said structure.
